(19) United States
(12) Patent Application Publication
(10) Pub. No.: US 2010/0199729 A1
(43) Pub. Date: Aug. 12, 2010

(54) KEY FOB ASSEMBLY

(76) Inventors: Michael Joseph Zaitz, Royal Oak, MI (US); Jill Sara Logsdon, Madison Heights, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/672,680

(22) PCT Filed: Nov. 27, 2007
(86) PCT No.: PCT/US07/85573

§ 371 Date: Feb. 8, 2010

Related U.S. Application Data
(60) Provisional application No. 60/861,522, filed on Nov. 27, 2006.

(51) Int. Cl. E05B 65/12; E05B 35/00

(52) U.S. Cl. 70/237; 70/344

(57) ABSTRACT

An example key fob assembly includes a fob portion and a releasable portion releasably connected to the fob portion. A locking mechanism moves along a curved path between an engaged position and a disengaged position. The disengaged position permits separation of the fob portion from the releasable portion.

### CROSS REFERENCE TO RELATED APPLICATION

The application claims priority to U.S. Provisional Application No. 60/861522, which was filed on 27 Nov. 2006.

### BACKGROUND OF THE INVENTION

This application relates generally to a key fob assembly with a release mechanism that moves along a curved path. Key fob assemblies are known and used to initiate a wide variety of functions, particularly vehicle functions. Some key fobs include buttons for locking and unlocking a vehicle, for example. Vehicle operators often transport the key fob in their pocket or purse when not operating the vehicle. Although key fob assemblies include a vehicle keys, many vehicle operators also secure other keys to the key fob assembly, such as home keys and office keys.

Vehicle operators drive their vehicles to various establishments, some of which encourage or require valet parking. Although the vehicle operators give a vehicle key to the valet, turning over other keys to the valet is not desired. Key fob assemblies often include releasable vehicle keys that can be turned over to the valet. The retained portion of the fob includes other keys and personal items.

Incorporating releasable vehicle keys into key fobs often requires complex mechanisms and significant packaging space, which undesirably limit the styling options and increase the overall size of the key fob.

### SUMMARY

An example key fob assembly includes a fob portion and a releasable portion releasably connected to the fob portion. A locking mechanism moves along a curved path between an engaged and a disengaged position. The disengaged position permits the fob portion from the releasable portion.

The example key fob assembly may include a fob portion having a first vehicle key and a releasable portion having a second vehicle key The releasable portion releasably connects to the fob portion. A locking mechanism moves along a curved path between an engaged position and a disengaged position that permits more relative movement between the fob portion and the releasable portion than the disengaged position.

### BRIEF DESCRIPTION OF THE DRAWINGS

These and other features of the present invention can be best understood from the following specification and drawings, the following of which is a brief description:

FIG. 1 shows a top view of an example key fob assembly;

FIG. 2 shows a perspective view of the FIG. 1 key fob assembly with the valet key removed from an engaged position;

FIG. 3 shows a sectional view of the FIG. 1 key fob assembly through line III-III of FIG. 1;

FIG. 4 shows a top view of the FIG. 3 sectional view; and

FIG. 5 shows a sectional view of the FIG. 1 key fob assembly through line IV-IV of FIG. 3 with the valet key in an engaged position.

### DETAILED DESCRIPTION OF THE PREFERRED EMBODIMENT

Referring to FIG. 1, an example key fob assembly 20 includes a releasable portion 24 and a fob portion 28. A home key 36, a luggage key 40, and other personal items connect to the releasable portion 24 through a key ring 44. The fob portion 28 includes a lock button 50, an unlock button 54, a panic button 58 and a vehicle key 62.

When the assembly 20 is in an engaged position, the fob portion 28 engages the releasable portion 24. In this example, moving a locking mechanism 66 permits movement of the releasable portion 24 relative to the fob portion 28. In the engaged position, the locking mechanism 66 limits movement of the releasable portion 24 relative to the fob portion 28.

FIG. 2 illustrates the releasable portion 24 removed from the engaged position. A vehicle operator removes the releasable portion 24, which contains a second vehicle key 26, and gives the fob portion 28 to a valet. The vehicle key 62 on the fob portion 28 allows the valet to access the vehicle, and the second vehicle key 26 on the releasable portion 24 allows the vehicle operator to access the vehicle. The personal items, such as the home key 36 and the luggage key 40, remain with the vehicle operator on the releasable portion 24. Thus, the vehicle operator can permit the valet to access the vehicle using the vehicle key 62 without giving personal items to the valet.

Referring again to FIG. 1, the key fob assembly 20 includes an axis Y. The locking mechanism 66 moves along a curved path relative to the axis Y. In this example, curved section line aligns with the curved travel path of the locking mechanism 66. The locking mechanism 66 of FIG. 1 is shown in a first position that engages the removable portion 24 within the fob portion 28. The locking mechanism 66 is moveable to a second position that permits disengaging the removable portion 24 from the fob portion 28.

The releasable portion 24 includes an upper housing 70 defining a guide 78, which limits movement of the locking mechanism 66. In this example, the guide 78 directs the locking mechanism 66 toward the axis Y when moving the guide 78 toward the second position.

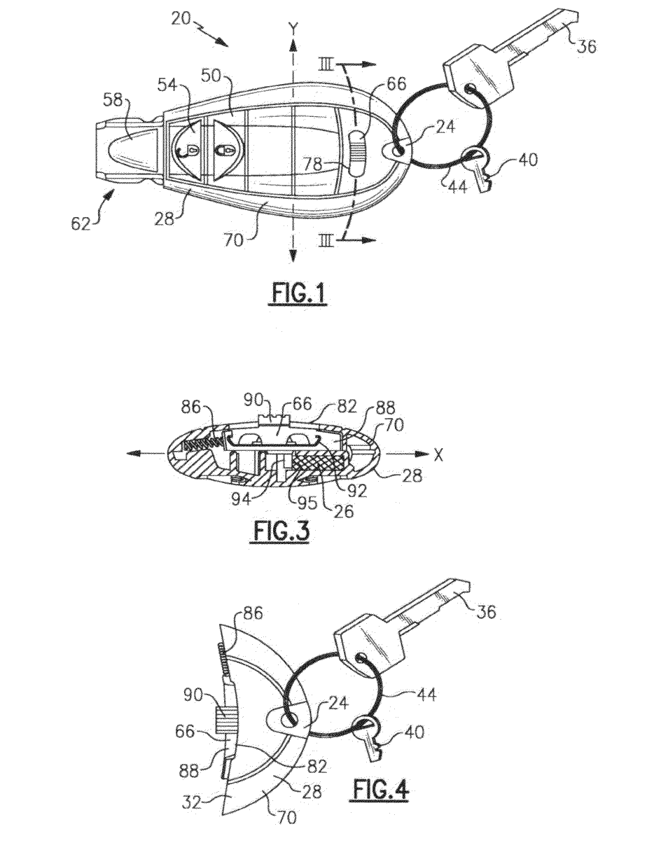

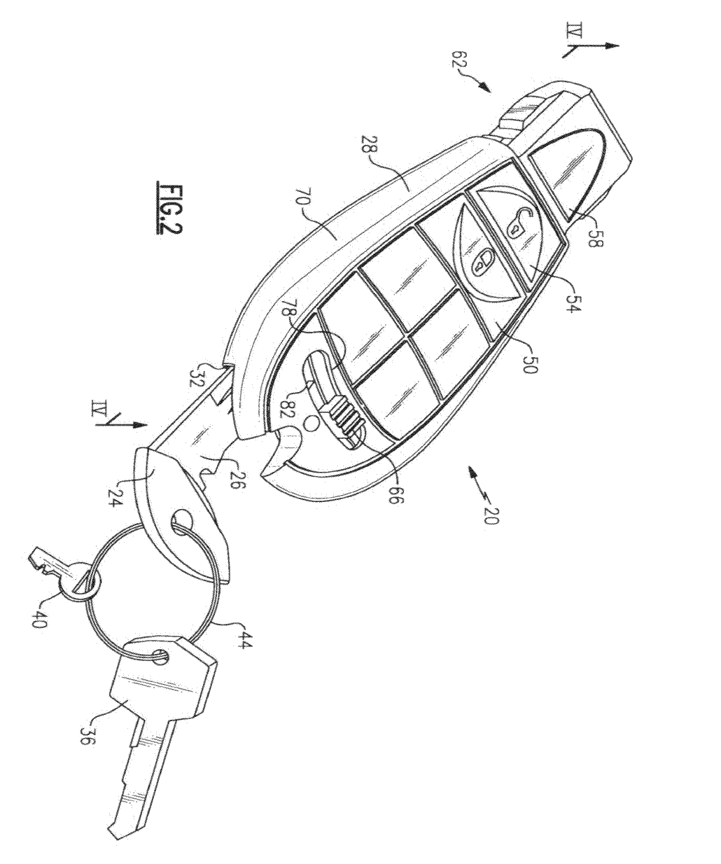

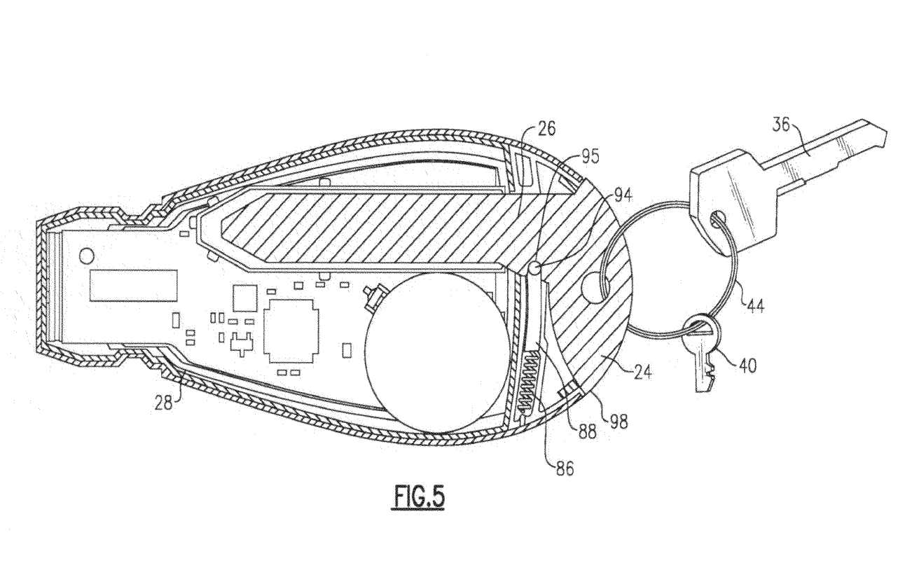

Referring now to FIGS. 3 and 4, the locking mechanism 66 includes a spring 86, a housing 88, and a thumb switch 90. The spring 86 biases the housing 88 and the switch 90 toward the first position corresponding to the engaged position of the key fob assembly 20. The housing 88 includes a recessed area 92 for receiving the switch 90. Accordingly, movement of the thumb switch 90 moves the housing 88 against biasing force of the spring 86

In the engaged position, a lock pin 94, a type of locking member, extending from the housing 88 is received within a recessed area 95 of the second vehicle key 26. The lock pin 94 contacts the second vehicle key 26 to prevent removing the releasable portion 24 from the fob portion 28. In this example, the housing 88 and the lock pin 94 are a metallic material, which is a stronger material than the polymer thumb switch 90, and facilitates maintaining the releasable portion 24 in the engaged position with the locking mechanism 66 is in the first position.

An axis X bisects the fob portion 28 in FIG. 3. As the locking mechanism 66 moves against the bias of the spring 86 from the first position to the second position, the locking mechanism 66 follows a curved path relative to axis X. In the first position shown, the locking mechanism 66 is further from the axis X than when the locking mechanism 66 is in the second position. The curved path of travel for the locking mechanism 66 facilitates the switch 90 following the outer surface profile of the upper housing 70, which is concave in this example. Accordingly, in this example, the path of travel for the locking mechanism 66 moving from the first position curves relative axis X and axis Y.

FIG. 5 shows the lock pin 94 within the recessed area 95 of the key 26. Moving the lock pin 94 from the recessed area 95 to the second position permits removal of the releasable portion 24 as the lock pin 94 no longer contacts the key 26.

In the engaged position, the fob portion 28 contacts the releasable portion 24 along a curved interface 98. The path of travel for the locking mechanism 66 curves away from the interface 98 in this example.

Although a preferred embodiment of this invention has been disclosed, a worker of ordinary skill in this art would recognize that certain modifications would come within the scope of this invention. For that reason, the following claims should be studied to determine the true scope and content of this invention.

1. A key fob assembly, comprising:
a fob portion;
a releasable portion releasably connected to said fob portion; and
a locking mechanism moveable along a curved path between a first position and a second position, said second position permitting more relative movement between said fob portion and said releasable portion than said first position.

2. The key fob assembly of claim 1, wherein said fob portion includes a fob housing having a concave profile.

3. The key fob assembly of claim 2, wherein movement of said locking mechanism between said first position and said second position aligns with the concave profile of said fob housing.

4. The key fob assembly of claim 1, wherein said fob portion contacts said releasable portion at an interface.

5. The key fob assembly of claim 4, wherein said lock mechanism moves away from the interface when said lock mechanism moves from said first position to said second position.

6. The key fob assembly of claim 4, wherein the interface comprises a curved interface.

7. The key fob assembly of claim 1, wherein said locking mechanism comprises a switch for moving said lock.

8. The key fob assembly of claim 7, wherein said switch comprises a polymer material.

9. The key fob assembly of claim 1, wherein said locking mechanism comprises a locking member for limiting movement of said releasable portion relative to said fob portion.

10. The key fob assembly of claim 9, wherein said locking member comprises a metallic material.

11. The key fob assembly of claim 1, including a spring for biasing said locking mechanism toward the first position.

12. The key fob assembly of claim 1, wherein said lock mechanism moves toward a key end of said fob portion when said lock mechanism moves from the first position to the second position.

13. A key fob assembly, comprising:
a fob portion having a first vehicle key;
a releasable portion having a second vehicle key, said releasable portion releasably connected to said fob portion; and
a locking mechanism moveable along a curved path between an engaged position and a disengaged position that permits separation of said fob portion from said releasable portion.

14. The key fob assembly of claim 13, wherein the curved path curves toward a key end of said fob portion.

15. The key fob assembly of claim 13, wherein said fob portion includes a concave upper housing.

16. The key fob assembly of claim 15, wherein the curved path is aligned with said concave upper housing.

17. The key fob assembly of claim 13, wherein said releasable portion connects to a key ring.

18. The key fob assembly of claim 13, wherein said fob portion contacts said releasable portion at an interface.

19. The key fob assembly of claim 18, wherein said lock mechanism moves away from the interface when said lock mechanism moves from the first position to the second position.

20. The key fob assembly of claim 18, wherein the interface comprises a curved interface.
